(19) United States
(12) Patent Application Publication
(10) Pub. No.: US 2008/0206553 A1
(43) Pub. Date: Aug. 28, 2008

(54) Dispersion for Application of a Metal Layer

(75) Inventors: Norbert Schneider, Altrip (DE); Gerald Lippert, Lampertheim (DE); Rene Lochtman, Mannheim (DE); Heiko Maas, Mannheim (DE); Jurgen Pfister, Speyer (DE); Bettina Sobotka, Mannheim (DE); Norbert Wagner, Mutterstadt (DE)

Correspondence Address: CONNOLLY BOVE LODGE & HUTZ LLP, 1875 EYE STREET, N.W., SUITE 1100, WASHINGTON, DC, 20036, US

(73) Assignee: BASF SE, Ludwigshafen (DE)

(21) Appl. No.: 12/066,340

(22) PCT Filed: Aug. 31, 2006
(86) PCT No.: PCT/EP06/65875

§ 371 Date: Mar. 10, 2008

(30) Foreign Application Priority Data
Sep. 8, 2005 (DE) 10 2005 043 242.5

(51) Int. Cl. B32B 33/00; C09D 5/24; C25D 5/54; B05D 5/12

(52) U.S. Cl. 428/328; 428/323; 205/159; 427/126.3; 524/413; 524/435; 524/436; 524/437; 428/330

(57) ABSTRACT

The present invention relates to a dispersion for application of a metal layer on a substrate that is not electrically conductive, comprising an organic binder component, a metal component with different metals and/or metal particle shapes, and with a solvent component. The invention moreover relates to a process for preparation of the dispersion, to a process using the dispersion for production of a metal layer, if appropriate structured, and to the resultant substrate surfaces and their use.

The present invention relates to a dispersion for application of a metal layer, to processes for its preparation, and to processes using the dispersion for production of a metal layer on a substrate. The invention further relates to substrate surfaces thus coated and to their use.

Various techniques are known for production of electrically conductive metallic layers on substrates which do not conduct electrical current. For example, substrates which are not electrically conductive, e.g. plastics, can be metallized in a high vacuum, but these processes are complicated and expensive.

The usual method of metallizing plastics carries out a number of steps in series in a process. The process here begins by using strong acids or bases in a surface-activation step. Substances hazardous to health are often used here, an example being chromic-sulfuric acid. The plastics surface is then coated via solutions with suitable transition metal complexes. These permit metallization of the activated plastic surface in this process.

However, another method of obtaining conductive coatings on surfaces that are not electrically conductive uses conductive lacquers or conductive pastes, these being applied to the plastic, but they have to have good adhesion to the material.

DE-A 1 615 786 describes by way of example use of a lacquer layer comprising finely dispersed iron in processes for production of electrically conductive layers on surfaces that are not electrically conductive. The lacquer is moreover intended to comprise an organic solvent and certain proportions of binder.

However, it is known that these conductive lacquers have only relatively small conductivities, because the dispersed metallic particles do not form a coherent conductive layer through the binder. The conductivities of these layers do not therefore achieve those of comparable-thickness metal foils. An increase in the content of metal pigment within the layer would also lead to an increase in conductivities, but problems frequently occur here because of inadequate adhesion of the conductive layer on the plastics surface.

DE-A 1 521 152 therefore proposes applying, to the surface that is not electrically conductive, a conductive lacquer which comprises a binder and comprises finely dispersed iron, and then, by a currentless method, applying, to the conductive lacquer, a layer of silver or of copper. A further layer can then be applied by a currentless or electroplating method. EP-B 200 772 describes using fluid organic paint binder to coat an article that is not electrically conductive, in order to achieve electromagnetic screening at a frequency above 10 kHz. That process begins by applying a primary layer with the fluid organic paint binder, in which active metal particles have been dispersed, and a second layer of copper is deposited by a currentless method on the primary layer, and finally a third layer composed of an electroplatinized metal is applied to the second layer.

DE-A 199 45 400 describes inter alia a magnetic dispersion which is intended to comprise a specific binder and a magnetic or magnetizable material.

There is a requirement for optimized systems for metallic coating of substrates that are not electrically conductive where in particular these have improved adhesion and are environmentally compatible, inexpensive, and reliable, and can be used at high operating speed. The systems known within the prior art have not hitherto permitted large-scale industrial utilization.

It is therefore an object of the present invention to provide a dispersion which permits application of a metal layer on a substrate that is not electrically conductive, in particular permitting achievement of increased adhesion and/or layer homogeneity of the metal layer.

This object is achieved via a dispersion for application of a metal layer on a substrate that is not electrically conductive, comprising

A from 0.01 to 30% by weight, based on the total weight of the dispersion, of an organic binder component;

B from 30 to 89.99% by weight, based on the total weight of the dispersion, of a metal component at least comprising
B1 from 0.01 to 99.99% by weight, based on the total weight of the metal component B, of a first metal with a first metal particle shape, and
B2 from 99.99 to 0.01% by weight, based on the total weight of the metal component B, of a second metal with a second metal particle shape;

C from 10 to 69.99% by weight, based on the total weight of the dispersion, of a solvent component;

where at least one of the following conditions has been met:

(1) the first and second metal are different;

(2) the first and second particle shape are different.

Specifically, it has been found that the presence of different metals and/or particle shapes in the inventive dispersion can, after application, give a metallic primary layer which, together with a further metallic layer that is applied by a currentless and/or electroplating method, gives a metal layer having improved properties.

The dispersion can moreover comprise one of the following components:

D) from 0.01 to 50% by weight, based on the total weight of the dispersion, of a dispersing agent component; and

E) from 0.01 to 50% by weight, based on the total weight of the dispersion, of a filler component.

### Component A

The organic binder component A is a binder or binder mixture. Possible binders are binders having an anchor group that has pigment affinity, naturally occurring and synthetic polymers and their derivatives, naturally occurring resins and synthetic resins and their derivatives, natural rubber, synthetic rubber, proteins, cellulose derivatives, drying and non-drying oils, and the like. These can - but do not have to be - substances that cure chemically or physically, for example air-curing, radiation-curing, or heat-curing substances.

The binder component A is preferably a polymer or polymer mixture.

Polymers preferred as component A are ABS (acrylonitrile-butadiene-styrene); ASA (acrylonitrile-styrene-acrylate); acrylated acrylates; alkyd resins; alkylvinyl acetates; alkylene-vinyl acetate copolymers, in particular methylene-vinyl acetate, ethylene-vinyl acetate, butylene-vinyl acetate; alkylene-vinyl chloride copolymers; amino resins; aldehyde resins and ketone resins; cellulose and cellulose derivatives, in particular alkylcellulose, cellulose esters, such as cellulose acetates, cellulose propionates, cellulose butyrates, cellulose ethers, carboxyalkylcelluloses, cellulose nitrate; epoxy acrylates; epoxy resins; ethylene-acrylic acid copolymers; hydrocarbon resins; MABS (transparent ABS having acrylate units present); maleic anhydride copolymers; methacrylates, if appropriate amine-functionalized; natural rubber; synthetic rubber; chlorinated rubber; naturally occurring resins; rosins; shellac; phenolic resins; polyesters; polyester resins, such as phenyl ester resins; polysulfones; polyether sulfones; polyamides; polyimides; polyanilines; polypyrroles; polybutylene terephthalate (PBT); polycarbonate (e.g. Makrolon® from Bayer AG); polyester acrylates; polyether acrylates; polyethylene; polyethylene-thiophenes; polyethylene naphthalates; polyethylene terephthalate (PET); polyethylene terephthalate glycol (PETG); polypropylene; polymethyl methacrylate (PMMA); polyphenylene oxide (PPO); polytetrafluoroethylene (PTFE); polytetrahydrofuran; polyvinyl compounds, in particular polyvinyl chloride (PVC), PVC copolymers, PVdC, polyvinyl acetate, and copolymers of these, polyvinyl alcohol if appropriate in partially hydrolyzed form, polyvinyl acetates, polyvinylpyrrolidone, polyvinyl ethers, polyvinyl acrylates, and polyvinyl methacrylates in solution and in the form of a dispersion, and their copolymers, polyacrylic esters and polystyrene copolymers; polystyrene (impact-resistant or without impact modification; polyurethanes, non-crosslinked or treated with isocyanates; polyurethane acrylates; styrene-acrylic copolymers; styrene-butadiene block copolymers (e.g. Styroflex® or Styrolux® from BASF AG, K-Resin™ from CPC); proteins, e.g. casein; SIS; SPS block copolymers. Mixtures of two or more polymers can moreover form the organic binder component A).

Polymers preferred as component A are polyalkylenes, polyimides, epoxy resins, and phenolic resins, styrene-butadiene block copolymers, alkylene-vinyl acetates and alkylene-vinyl chloride copolymers, polyamides, and their copolymers.

The content of the organic binder component A), based on the total weight of the dispersion, is from 0.01 to 30% by weight. The content is preferably from 0.1 to 10% by weight, more preferably from 0.5 to 5% by weight.

### Component B

The metal component B comprises at least one first metal with a first metal particle shape and one second metal with a second metal particle shape.

The first metal can be a metal which is identical with or different from the second metal.

The first metal particle shape can likewise be identical with or different from the second metal particle shape. However, it is important that at least the metals or the particle shapes are different. However, it is also possible that not only the first and the second metal, but also the first and second particle shape, are different from one another.

The dispersion can comprise, alongside the metal components B1 and B2, further metals which differ from the first and second metal, or differ from the first or second metal, or are identical with the first and second metal. Similar considerations apply to the metal particle shape of a further metal. For the purposes of the present invention the only requirement is that at least one first and second metal, and one first metal particle shape and one second metal particle shape are present, with the proviso that the first and second metal are different and/or that the first and second particle shape are different from one another.

For the purposes of the present invention, the oxidation state of the metals is 0, and they can be added in the form of metal powder to the dispersion.

The average particle diameter of the metals is preferably from 0.01 to 100 μm, with preference from 0.05 to 50 μm, and with particular preference from 0.1 to 10 μm. The average particle diameter can be determined by means of laser scattering measurements, for example on Microtrac X100 equipment. The particle diameter distribution depends on the preparation process for the particles. The diameter distribution typically has only one maximum, but two or more maxima are also possible.

Examples of suitable metals are zinc, nickel, copper, tin, cobalt, manganese, iron, magnesium, lead, chromium, bismuth, silver, gold, aluminum, titanium, palladium, platinum, tantalum, and alloys thereof. Examples of suitable alloys are CuZn, CuSn, CuNi, SnPb, SnBi, SnCo, NiPb, ZnFe, ZnNi, ZnCo, and ZnMn. Iron, zinc, aluminum, and copper are particularly preferred.

The metal can also comprise non-metallic content alongside the metallic content. For example, the surface of the metal can have been provided at least to some extent with a coating. Suitable coatings can be of inorganic (e.g. SiO₂, phosphates) or organic type. The metal can, of course, also have been coated with a further metal or metal oxide. The metal can likewise be present in partially oxidized form.

If the intention is that two different metals form the metal component B, this can be achieved via mixing of two metals. The two metals have particularly preferably been selected from the group consisting of iron, zinc, aluminum, and copper.

However, the metal component B can also comprise a first metal and a second metal in which the second metal is present in the form of an alloy (with the first metal or with one or more other metals), or the metal component B can comprise two different alloys. Again in these two instances, the metal components B1 and B2 differ from each other, thus permitting their metal particle shape to be selected to be identical or different, independently of one another.

Alongside the selection of the metals, the metal particle shape of the metals has an effect on the properties of the inventive dispersion after a coating process. With respect to the shape, there are numerous possible variants known to the person skilled in the art. By way of example, the shape of the metal particle can be acicular, cylindrical, lamellar, or spherical. These particle shapes represent idealized shapes, and the actual shape here can be one that has been modified to a greater or lesser extent therefrom, for example as a function of the production process. By way of example, therefore, droplet-shaped particles are for the purposes of the present invention, a practical modification of the idealized spherical shape.

Metals with various particle shapes are commercially available.

If the metal component B1 and metal component B2 differ in their metal particle shape, it is preferable that the first is spherical and the second is lamellar or acicular.

When the particle shapes are different, the preferred metals are likewise iron, copper, zinc, and aluminum.

As stated above, the metals can be in the form of their powders when added to the dispersion. These metal powders are familiar commercial products, or can readily be prepared by means of known processes, for example via electrolytic deposition or chemical reduction from solutions of the metal salts or via reduction of an oxidic powder, for example by means of hydrogen, via spraying of a molten metal, in particular into coolants, such as gases or water. Gas spraying and water spraying are preferred.

In the case of iron, the carbonyl iron powder process (CIP) is preferred for production of carbonyl iron powder, alongside the gas spraying and water spraying process. The CIP process uses thermal decomposition of pentacarbonyliron. This process is described by way of example in Ullman's Encyclopedia of Industrial Chemistry, 5th Edition, Vol. A14, page 599. The decomposition of pentacarbonyliron can by way of example take place at elevated temperatures and elevated pressures in a heatable decomposition vessel comprising a pipe which is composed of heat-resistant material, such as quartz glass or V2A steel, in preferably vertical position, and which has a surrounding heater, for example composed of heating baths, of heating wires, or of a heating jacket through which heating fluid passes.

Lamellar metals can be controlled via optimized conditions in the preparation process, or obtained subsequently via mechanical treatment, for example via treatment in a ball mill with agitator.

Based on the total weight of the dispersion, the content of the metal component B is from 30 to 89.99% by weight. The content of metal subcomponent Bi is from 99.99 to 0.01% by weight, based on the total weight of component B. The content of metal subcomponent B2 is from 0.01 to 99.99% by weight. If no further metals are present, B1 and B2 give 100% of metal component B.

A preferred range for B is from 50 to 85% by weight, based on the total weight of the dispersion.

The ratio by weight of components B1 and B2 is preferably in the range from 1000:1 to 1:1, more preferably from 100:1 to 1:1, most preferably from 20:1 to 1:1.

### Component C

The inventive dispersion moreover comprises a solvent component C. This is composed of a solvent or of a solvent mixture.

Suitable solvents are acetone, alkyl acetates, alkoxypropanols (e.g. methoxypropanol), amyl alcohol, butanol, butyl acetate, butyl diglycol, alkyl glycol acetates, such as butyl glycol acetate, butyl glycol, chloroform, cyclohexane, cyclohexanone, diacetone alcohol, diethyl ether, diglycol dimethyl ether, dioxane, ethanol, ethyl acetate, ethylbenzene, ethylene chloride, ethylene glycol, ethylene glycol acetate, ethylene glycol dimethyl ester, isobutanol, isobutyl acetate, isopropyl acetate, cresol, methanol, methoxybutanol, methyl acetate, 3-methylbutanol, methyl diglycol, methylene chloride, methylene glycol, methyl ethyl ketone (MEK), methyl isobutyl ketone (MIBK), methyl glycol acetate, methylphenol (ortho-, meta-, para-cresol), 1-propanol, 2-propanol, propyl acetate, propylene glycol, carbon tetrachloride, tetrahydrofuran, toluene, trimethylolpropane (TMP), alcoholic monoterpines (e.g. terpineol), water, and mixtures composed of two or more of these solvents.

Preferred solvents are alkoxypropanol, cyclohexane, ethanol, ethyl acetate, butyl acetate, 1-propanol, 2-propanol, tetrahydrofuran, ethylbenzene, butyl glycol acetate, water, and mixtures thereof.

The content of solvent component C, based on the total weight of the dispersion, is from 10 to 69.99% by weight. The content is preferably from 15 to 50% by weight.

### Component D

The inventive dispersion can moreover comprise a dispersing agent component D. This is composed of one or more dispersing agents.

In principle, any of the dispersing agents described in the prior art and known to the person skilled in the art for use in dispersions is suitable. Preferred dispersing agents are surfactants or surfactant mixtures, for example anionic, cationic, amphoteric, or non-ionic surfactants.

Cationic and anionic surfactants are described by way of example in “Encyclopedia of Polymer Science and Technology”, J. Wiley & Sons (1966), Volume 5, pp. 816 to 818, and in “Emulsion Polymerisation and Emulsion Polymers”, editors P. Lovell and M. El-Asser, Verlag Wiley & Sons (1997), pp. 224-226.

Examples of anionic surfactants are alkali metal salts of organic carboxylic acids having chain lengths of from 8 to 30 carbon atoms, preferably from 12 to 18 carbon atoms. These are generally termed soaps. The salts usually used are the sodium, potassium, or ammonium salts. Other anionic surfactants which may be used are alkyl sulfates and alkyl- or alkylarylsulfonates having from 8 to 30 carbon atoms, preferably from 12 to 18 carbon atoms. Particularly suitable compounds are alkali metal dodecyl sulfates, e.g. sodium dodecyl sulfate or potassium dodecyl sulfate, and alkali metal salts of C₁₂-C₁₆ paraffinsulfonic acids. Other suitable compounds are sodium dodecylbenzenesulfonate and sodium dioctyl sulfosuccinate.

Examples of suitable cationic surfactants are salts of amines or of diamines, quaternary ammonium salts, e.g. hexadecyltrimethylammonium bromide, and also salts of long-chain substituted cyclic amines, such as pyridine, morpholine, piperidine. Use is particularly made of quaternary ammonium salts of trialkylamines, e.g. hexadecyltrimethylammonium bromide. The alkyl radicals here preferably have from 1 to 20 carbon atoms.

According to the invention, nonionic surfactants may in particular be used in component D. Nonionic surfactants are described by way of example in CD Römpp Chemie Lexikon—Version 1.0, Stuttgart/New York: Georg Thieme Verlag 1995, keyword “Nichtionische Tenside” [Nonionic surfactants].

Examples of suitable nonionic surfactants are polyethylene-oxide- or polypropylene-oxide-based substances, such as Pluronic® or Tetronic® from BASF Aktiengesellschaft.

Polyalkylene glycols suitable as nonionic surfactants generally have a molar mass Mₙ in the range from 1 000 to 15 000 g/mol, preferably from 2 000 to 13 000 g/mol, particularly preferably from 4 000 to 11 000 g/mol. Preferred nonionic surfactants are polyethylene glycols.

The polyalkylene glycols are known per se or may be prepared by processes known per se, for example by anionic polymerization using alkali metal hydroxide catalysts, such as sodium hydroxide or potassium hydroxide, or using alkali metal alkoxide catalysts, such as sodium methoxide, sodium ethoxide, potassium ethoxide or potassium isopropoxide, and with addition of at least one starter molecule which comprises from 2 to 8 reactive hydrogen atoms, preferably from 2 to 6 reactive hydrogen atoms, or by cationic polymerization using Lewis acid catalysts, such as antimony pentachloride, boron fluoride etherate, or bleaching earth, the starting materials being one or more alkylene oxides having 2 to 4 carbon atoms in the alkylene radical.

Examples of suitable alkylene oxides are tetrahydrofuran, butylene 1,2- or 2,3-oxide, styrene oxide, and preferably ethylene oxide and/or propylene 1,2-oxide. The alkylene oxides may be used individually, alternating one after the other, or as a mixture. Examples of starter molecules which may be used are: water, organic dicarboxylic acids, such as succinic acid, adipic acid, phthalic acid, or terephthalic acid, aliphatic or aromatic, unsubstituted or N-mono-, or N,N- or N,N′-dialkyl-substituted diamines having from 1 to 4 carbon atoms in the alkyl radical, such as unsubstituted or mono- or dialkyl-substituted ethylenediamine, diethylenetriamine, triethylenetetramine, 1,3-propylenediamine, 1,3- or 1,4-butylenediamine, or 1,2-, 1,3-, 1,4-, 1,5- or 1,6-hexamethylenediamine.

Other starter molecules which may be used are: alkanolamines, e.g. ethanolamine, N-methyl- or N-ethylethanolamine, dialkanolamines, e.g. diethanolamine, and N-methyl-and N-ethyldiethanolamine, and trialkanolamines, e.g. triethanolamine, and ammonia. It is preferable to use polyhydric alcohols, in particular di- or trihydric alcohols or alcohols with functionality higher than three, for example ethanediol, 1,2-propanediol, 1,3-propanediol, diethylene glycol, dipropylene glycol, 1,4-butanediol, 1,6-hexanediol, glycerol, trimethylolpropane, pentaerythritol, sucrose, and sorbitol.

Other suitable components D are esterified polyalkylene glycols, such as the mono-, di-, tri- or polyesters of the polyalkylene glycols mentioned which can be prepared by reacting the terminal OH groups of the polyalkylene glycols mentioned with organic acids, preferably adipic acid or terephthalic acid, in a manner known per se.

Nonionic surfactants are prepared by alkoxylating compounds having active hydrogen atoms, for example adducts of alkylene oxide onto fatty alcohols, oxo alcohols, or alkylphenols. It is preferable to use ethylene oxide or 1,2-propylene oxide for the alkoxylation reaction.

Other possible nonionic surfactants are alkoxylated or nonalkoxylated sugar esters or sugar ethers.

Sugar ethers are alkyl glycosides obtained by reacting fatty alcohols with sugars, and sugar esters are obtained by reacting sugars with fatty acids. The sugars, fatty alcohols, and fatty acids needed to prepare the substances mentioned are known to the person skilled in the art.

Suitable sugars are described by way of example in Beyer/Walter, Lehrbuch der organischen Chemie, S. Hirzel Verlag Stuttgart, 19th edition, 1981, pp. 392 to 425. Possible sugars are D-sorbitol and the sorbitans obtained by dehydrating D-sorbitol.

Suitable fatty acids are saturated or singly or multiply unsaturated unbranched or branched carboxylic acids having from 6 to 26 carbon atoms, preferably from 8 to 22 carbon atoms, particularly preferably from 10 to 20 carbon atoms, for example as mentioned in CD Römpp Chemie Lexikon-Version 1.0, Stuttgart/New York: Georg Thieme Verlag 1995, keyword “Fettsäuren” [Fatty acids]. Preferred fatty acids are lauric acid, palmitic acid, stearic acid, and oleic acid.

The carbon skeleton of suitable fatty alcohols is identical with that of the compounds described as suitable fatty acids.

Sugar ethers, sugar esters, and the processes for their preparation are known to the person skilled in the art. Preferred sugar ethers are prepared by known processes, by reacting the sugars mentioned with the fatty alcohols mentioned. Preferred sugar esters are prepared by known processes, by reacting the sugars mentioned with the fatty acids mentioned. Preferred sugar esters are the mono-, di-, and triesters of the sorbitans with fatty acids, in particular sorbitan monolaurate, sorbitan dilaurate, sorbitan trilaurate, sorbitan monooleate, sorbitan dioleate, sorbitan trioleate, sorbitan monopalmitate, sorbitan dipalmitate, sorbitan tripalmitate, sorbitan monostearate, sorbitan distearate, sorbitan tristearate, and sorbitan sesquioleate, a mixture of sorbitan mono- and dioleates.

Possible components D are hence alkoxylated sugar ethers and sugar esters obtained by alkoxylating the sugar ethers and sugar esters mentioned. Preferred alkoxylating agents are ethylene oxide and propylene 1,2-oxide. The degree of alkoxylation is generally from 1 to 20, preferably 2 to 10, particularly preferably from 2 to 6. Examples of these are polysorbates obtained by ethoxylating the sorbitan esters described above, for example as described in CD Römpp Chemie Lexikon—Version 1.0, Stuttgart/New York: Georg Thieme Verlag 1995, keyword “Polysorbate” [Polysorbates]. Suitable polysorbates are polyethoxysorbitan laurate, stearate, palmitate, tristearate, oleate, trioleate, in particular polyethoxysorbitan stearate, which is obtainable, for example, as Tween®60 from ICI America Inc. (described by way of example in CD Römpp Chemie Lexikon—Version 1.0, Stuttgart/New York: Georg Thieme Verlag 1995, keyword “Tween®”).

It is also possible to use polymers as dispersing agents.

The amount used of the dispersing agent component D can be from 0.01 to 50% by weight, based on the total weight of the dispersion. The content is preferably from 0.1 to 10% by weight, particularly preferably from 0.3 to 5% by weight.

### Component E

The inventive dispersion can moreover comprise a filler component E. This can be composed of one filler or of two or more fillers. By way of example, component E of the metallizable composition can comprise fibrous or particulate fillers or a mixture of these. They are preferably commercially available products, such as carbon fibers and glass fibers.

Glass fibers that can be used can be composed of E, A, or C glass, and have preferably been equipped with a size and with a coupling agent. Their diameter is generally from 1 to 20 μm. It is possible to use either continuous-filament fibers (rovings) or else chopped glass fibers (staple) whose length is from 1 to 10 mm, preferably from 3 to 6 mm.

It is also possible to use fillers or reinforcing materials such as glass powder, glass textile, glass nonwoven, mineral fibers, whiskers, aluminum oxide fibers, mica, powdered quartz, or wollastonite. It is also possible to use carbon, silica, silicates, e.g. Aerosils or phyllosilicates, dyes, fatty acids, fatty amides, plasticizers, wetting agents, desiccants, complexing agents, calcium carbonate, barium sulfate, waxes, pigments, conductive polymer particles, or aramid fibers.

The content of component E, based on the total weight of dispersion, is preferably from 0.01 to 50% by weight. Further preference is given to from 0.1 to 10% by weight, and particular preference is given to from 0.3 to 5% by weight.

Processing aids and stabilizers can moreover be present in the inventive dispersion, examples being UV stabilizers, lubricants, corrosion inhibitors, and flame retardants. Their content, based on the total weight of the dispersion, is usually from 0.01 to 5% by weight. The content is preferably from 0.05 to 3% by weight.

The present invention further provides a process for preparation of the inventive dispersion, the steps comprising

A mixing of components A to C and, if appropriate, D and E, and of further components, and

B dispersion of the mixture.

The dispersion can be prepared via intensive mixing and dispersion, using assemblies known to persons skilled in the art. This includes mixing of the components in a dissolver or in a comparably intensively dispersing assembly, dispersion in a ball mill with agitator, or dispersion in a powder fluidizer for large amounts.

The present invention further provides a process for production of a metal layer on at least one portion of the surface of a substrate that is not electrically conductive, the steps comprising

a) application of an inventive dispersion on the substrate;

b) drying and/or hardening of the applied layer on the substrate; and

c) if appropriate, deposition of a metal by a currentless and/or electroplating method on the dried and/or hardened dispersion layer.

A suitable substrate is provided by materials that are not electrically conductive, for example polymers. Suitable polymers are epoxy resins, e.g. bifunctional or polyfunctional, aramid-reinforced or glassfiber-reinforced, or paper-reinforced epoxy resins, (e.g. FR4), glassfiber-reinforced plastics, liquid-crystal polymers (LCPs), polyphenylene sulfides (PPSs), polyoxymethylenes (POMs), polyaryl ether ketones (PAEKs), polyether ether ketones (PEEKs), polyamides (PAs), polycarbonates (PCs), polybutylene terephthalates (PBTs), polyethylene terephthalates (PETs), polyimides (PIs), polyimide resins, cyanate esters, bismaleimide-triazine resins, nylon, vinyl ester resins, polyesters, polyester resins, polyamides, polyanilines, phenolic resins, polypyrroles, polynaphthalene terephthalates, polymethyl methacrylate, phosphorus-modified epoxy resins, polyethylenedioxythiophenes, phenolic-resin-coated aramid paper, polytetrafluoroethylene (PTFE), melamine resins, silicone resins, fluororesins, dielectric materials, APPE, polyetherimides (PEIs), polyphenylene oxides (PPOs), polypropylenes (PPs), polyethylenes (PEs), polysulfones (PSUs), polyether sulfones (PESs), polyarylamides (PAAs), polyvinyl chlorides (PVCs), polystyrenes (PSs), acrylonitrile-butadiene-styrenes (ABSs), acrylonitrile-styrene-acrylates (ASAs), styrene-acrylonitriles (SANs), and mixtures (blends) of two or more of the abovementioned polymers, which may be present in a very wide variety of forms. The substrates can comprise additives known to the person skilled in the art, an example being flame retardants.

In principle, it is also possible to use any of the polymers listed under component A. Other substrates that are likewise conventional in the printed-circuit-board industry are also suitable.

Other suitable substrates are composite materials, foam-like polymers, Styropor®, Styrodur®, ceramic surfaces, textiles, cardboard, paperboard, paper, polymer-coated paper, wood, mineral materials, glass, plant tissue, and animal tissue.

For the purposes of the present invention, the term “not electrically conductive” preferably means specific resistance of more than 109 ohm x cm.

The dispersion can be applied by methods known to the person skilled in the art. Application to the substrate surface can take place on one or more sides and can extend over one, two or three dimensions. The substrate can generally have any desired geometry appropriate for the intended use.

The applied layer is also dried by conventional methods. As an alternative, the binder can also be hardened by a chemical or physical route, for example via UV radiation or heat.

The drying and/or hardening can be effected completely or partially.

The layer obtained after application of the dispersion and drying and/or hardening permits subsequent deposition of a metal by a currentless and/or electroplating method on the dried dispersion layer.

The inventive dispersion can be applied in structured or full-surface form in step a). It is preferable for the steps of the application process (step a), of the drying and/or hardening process (step b), and, if appropriate, of deposition of a further metal (step c) to be carried out in a continuous procedure. This is possible by virtue of the simple conduct of steps a), b), and, if appropriate, c). However, it is also possible to use a batch process or semicontinuous process, of course.

The coating process can use the conventional and well-known coating methods (casting, spreading, doctoring, brushing, printing (intaglio print, screen print, flexographic print, tampon print, InkJet, offset, etc.), spraying, dipping, powdering, fluidized-bed, etc.). The layer thickness preferably varies from 0.01 to 100 μm, with further preference from 0.1 to 50 μm, particularly preferably from 1 to 25 μm. The layers can be applied either in full-surface form or else in structured form.

The metal deposition carried out in step c) by a currentless and/or electroplating method can be carried out by methods known to the person skilled in the art and described in the literature. One or more metal layers may be applied by a currentless method and/or an electroplating method, i.e. with supply of external voltage and current flow. In principle, metals that can be used for the deposition process by a currentless and/or electroplating method are any of those which are more noble than or as noble as the least noble metal of the dispersion. Preference is given to deposition of copper layers, chromium layers, silver layers, gold layers, and/or nickel layers by an electroplating method. Preference is also given to deposition of layers composed of aluminum by an electroplating method. The thicknesses of the one or more layers deposited in step c) are in the conventional range known to the person skilled in the art and are not important for the invention.

The present invention further provides a substrate surface with at least partially present electrically conductive metal layer, obtainable by the inventive process described above for production of a metal layer.

This type of substrate surface can be used for conductive electrical current or heat, for screening from electromagnetic radiation, or else for magnetization.

The present invention further provides the use of an inventive dispersion for application of a metal layer.

The inventive substrate surface can in particular be used for various uses listed below.

Examples of possibilities are production of conductor-track structures, e.g. for production of antennas, such as RFID antennas, transponder antennas, printed-circuit boards (multilayer inner and outer layers, microvia, chip-on-board, flexible and rigid printed-circuit boards, paper, and composites, etc.), ribbon cables, seat-heating systems, contactless chip cards, capacitors, resistances, connectors, foil conductors, or electrical fuses.

A further possibility is production of antennas with contacts for organic electronic components, or else of coatings on surfaces composed of material that is not electrically conductive for electromagnetic screening (shielding) purposes.

Another possibility is production of a metallic inner coating for production of hollow conductors for high-frequency signals with a mechanical-load-bearing structure composed of material that is not electrically conductive. The substrate surface can also be a portion of film capacitors.

There is another possible use in the sector of flow fields of bipolar plates for use in fuel cells.

Another possibility is production of a full-surface or structured electrically conductive layer for the subsequent decorative metallization of moldings composed of the abovementioned substrate that is not electrically conductive. Production of metal foams is also conceivable (e.g. for crash absorbers).

The scope of use of the inventive process for production of a metal layer with the aid of the inventive dispersion and of the inventive substrate surface permits low-cost production of metallized substrates which are not themselves conductive, in particular for use as switches, sensors, and MIDs (molded interconnect devices), absorbers for electromagnetic radiation, or gas barriers, or decorative parts, in particular decorative parts for the motor vehicle, sanitary, toy, household, or office sector, and packaging, and foils. The invention can also be used in the sector of security printing for banknotes, credit cards, identity documents, etc. Textiles can be functionalized magnetically and electrically with the aid of the inventive process (transmitters, RFID antennas, transponder antennas and other antennas, sensors, heating elements, antistatic materials (inter alia for plastics), screening materials, etc.).

Examples of these applications are housings, such as computer housings, housings for display screens, mobile telephones, audio equipment, video equipment, DVDs, cameras, housings for electronic components, military and non-military screening devices, shower fittings and washstand fittings, shower heads, shower rails and shower holders, metallized door handles and doorknobs, toilet-paper-roll holders, bathtub grips, metallized decorative strips for furniture and mirrors, frames for shower partitions, packaging materials.

Other products which may be mentioned are: metallized plastics surfaces in the automobile sector, e.g. decorative strips, exterior mirrors, radiator grilles, front-end metallization, aerofoil surfaces, exterior bodywork parts, interior bodywork parts, doorsills, tread plate substitute, decorative wheel covers.

Furthermore, parts which have been produced hitherto to some extent or entirely from metals can be produced from non-conductive material. By way of example, mention may be made here of down pipes, gutters, doors, and window frames.

Another possibility here is production of contact sites or contact pads or wiring on an integrated electrical module.

The inventive dispersion can likewise be used for metallization of holes, of vias, of blind holes, etc. in printed-circuit boards, with the aim of establishing contact through the upper and lower side of the printed-circuit board. This also applies when other substrates are used.

The inventively produced metallized articles are moreover used - to the extent that they comprise magnetizable metals—in the sectors of magnetizable functional parts, e.g. magnetic panels, magnetic games, and magnetic surfaces in, for example, refrigerator doors. They are also used in sectors where good thermal conductivity is advantageous, for example in foils for seat-heating systems, floor-heating systems, and insulation materials.

Preferred uses of the inventively metallized substrate surface are those in which the resultant substrate serves as a printed-circuit board, RFID antenna, transponder antenna, seat-heating system, ribbon cable, or contactless chip cards.

### EXAMPLES

### Example 1

8.4 g of an ethylene-vinyl acetate copolymer are dissolved in 126 g of n-butyl acetate. 378 g of spherical iron powder and 42.0 g of lamellar copper powder are dispersed in this solution with the aid of a dissolver stirrer. The resultant dispersion is applied at thickness 4 μm to a primed PET foil. After the drying process, a copper layer of thickness 9 μm is applied in an acidic copper sulfate bath.

### Example 2

8.4 g of an ethylene-vinyl acetate copolymer are dissolved in 96.6 g of n-butyl acetate. 378 g of spherical iron powder and 42.0 g of lamellar copper powder are dispersed in this solution with the aid of a dissolver stirrer. The resultant dispersion is applied at thickness 4 μm to a primed PET foil. After the drying process, a copper layer of thickness 9 μm is applied in an acidic copper sulfate bath.

### Example 3

Example 1 is repeated using lamellar iron powder instead of lamellar copper powder.

### Example 4

Example 1 is repeated using carbonyl iron powder instead of conventional iron powder.

In all cases it is found that omission of one metal component in each case gives a less uniform copper layer which moreover also has poorer adhesion.

1. A dispersion for application of a metal layer on a substrate that is not electrically conductive, comprising
A from 0.01 to 30% by weight, based on the total weight of the dispersion, of an organic binder component;
B from 30 to 89.99% by weight, based on the total weight of the dispersion, of a metal component at least comprising
B1 from 0.01 to 99.99% by weight, based on the total weight of the metal component B, of a first metal with a first metal particle shape, and
B2 from 99.99 to 0.01% by weight, based on the total weight of the metal component B, of a second metal with a second metal particle shape;
C from 10 to 69.99% by weight, based on the total weight of the dispersion, of a solvent component;
where at least one of the following conditions has been met:
(1) the first and second metal are different;
(2) the first and second particle shape are different.

2. The dispersion according to claim 1, which moreover comprises at least one of the following components
D from 0.01 to 50% by weight, based on the total weight of the dispersion, of a dispersing agent component; and
E from 0.01 to 50% by weight, based on the total weight of the dispersion, of a filler component.

3. The dispersion according to claim 1, wherein the binder component A is composed of a polymer or polymer mixture.

4. The dispersion according to claim 1, wherein, if appropriate, the first and second metal have been coated, having been selected independently of one another from the group consisting of zinc, nickel, copper, tin, cobalt, manganese, iron, magnesium, lead, chromium, bismuth, silver, gold, aluminum, titanium, palladium, platinum, tantalum, and alloys thereof

5. The dispersion according to claim 1, wherein the first and second particle shape have been selected independently of one another from the group consisting of acicular, cylindrical, lamellar, and spherical.

6. The dispersion according to claim 1, wherein the first and second metal are different.

7. The dispersion according to claim 6, wherein the first metal and the second metal have been selected from the group consisting of iron, copper, zinc, and aluminum.

8. The dispersion according to claim 1, wherein the first and second particle shape are different.

9. The dispersion according to claim 8, wherein the first particle shape is spherical and the second particle shape is lamellar or acicular.

10. The dispersion according to claim 1, wherein the average particle diameter of the first and second metal is in the range from 0.01 to 100 μm.

11. A process for preparation of a dispersion according to claim 1, the steps comprising
A mixing of components A to C and, if appropriate, D and E, and of further components, and
B dispersion of the mixture.

12. A process for production of a metal layer on at least one portion of the surface of a substrate that is not electrically conductive, the steps comprising
a) application of a dispersion according to claim 1 on the substrate;
b) drying and/or hardening of the applied layer on the substrate; and
c) if appropriate, deposition of a metal by a currentless and/or electroplating method on the dried and/or hardened dispersion layer.

13. The process according to claim 12, wherein, in layer a), the dispersion is applied in structured or full-surface form.

14. The process according to claim 12, wherein at least one of the steps a), b), and, if appropriate, c) is carried out in an at least to some extent continuous procedure.

15. A substrate surface with an at least partially present electrically conductive metal layer obtainable from the process according to claim 12.

16-17. (canceled)

18. A method of applying a dispersion according to claim 1 for application of a metal layer.

19. A method of applying a dispersion according to claim 2 for application of a metal layer.

20. A method for applying a dispersion according to claim 3 for application of a metal layer.

21. A method selected from the group consisting of conducting an electrical current, conducting heat, providing a decorative metal surface, screening of electromagnetic radiation and for magnetization, which comprises applying the substrate surface according to claim 15.

22. The method according to claim 21 for providing a member selected from the group consisting of a printed circuit board, RFID antenna, transponder antenna, seat-heating system, ribbon cable, and contactless chip card.
